(19) United States
(12) Patent Application Publication
(10) Pub. No.: US 2003/0081240 A1
(43) Pub. Date: May 1, 2003

(54) Method and apparatus for adjusting print settings for a file

(76) Inventors: Jesus Soto, Barcelona (ES); Jordi Sender, Barcelona (ES); Manuel Gasset, Barcelona (ES); Juan Saez, Barcelona (ES)

Correspondence Address: HEWLETT-PACKARD COMPANY, Intellectual Property Administration, P.O. Box 272400, Fort Collins, CO, 80527-2400, US

(21) Appl. No.: 09/984,536

(22) Filed: Oct. 30, 2001

(51) Int. Cl. B41J 1/00; G06F 15/00

(52) U.S. Cl. 358/1.15

(57) ABSTRACT

A system and method for modifying print settings for a processed file is disclosed. An application generates a file to printed by a printing device. A print settings software is configured to modify print settings in the generated file prior to the file being printed. The print settings software generates a display of print settings that may be modified by a user. The user selects print settings, and the print settings software modifies a header file to include the user-selected print settings. The file is then printed with the user-selected print settings.

### FIELD OF THE INVENTION

The invention is generally related to adjusting print settings. More particularly, the invention is related to adjusting print settings for a file that has been generated by an application and includes information to be printed.

### BACKGROUND OF THE INVENTION

Typically, when a file is generated with an application, all the print settings are stored in the file. For example, when generating a file with PHOTOSHOP and a conventional driver (e.g., a driver for a HEWLETT-PACKARD 5000PS printer), a user may select print settings (e.g., print quality, size, color settings, and the like). Selected print settings and default print settings are stored in the generated file, including the information to be printed.

FIG. 4 illustrates a conventional flow of data for generating and printing a file. User print settings 410 are selected by a user and received by an application 415 (e.g., ADOBE PHOTOSHOP). The application 415 in combination with a printer driver 420 generates a file 425 including the print settings selected by the user, default print settings and an image to be printed (e.g., JPEG, TIFF, or the like). For example, the application 415 generates an image file 427 including the image to be printed. The application 415 also transmits the print settings to the printer driver 420 (e.g., the printer driver associated with the printer selected to print the image). The printer driver 420 generates a header file 426, including the print settings, that is packaged with the image file 427 (i.e., the header file and the image file are associated, such that the header file is transmitted to a printer just prior to the image file so the printer may adjust print settings to the settings in the header file). The file 425 is transmitted to the printer 430, and the printer 430 parses the header file 426 and adjusts its print settings to the print settings in the header file 426. The image file is printed by the printer 430 using the print settings from the header file 426.

The user may desire to change a print setting after the file 425 is generated. For example, if a high resolution print setting was selected, the file 425 may take an extended period of time to print. The user may cancel the print job, and change the resolution to a low resolution print setting for faster printing. However, the file 425 has already been generated with the high resolution print setting in the header file 426. Therefore, a new file must be generated with the new, low resolution print setting. The new file is stored in memory along with the existing file 425. Thus, system resources (e.g., memory, and the like) are inefficiently utilized, especially for image files that tend to consume large amounts of memory.

### SUMMARY OF THE INVENTION

An aspect of the present invention is to provide a method and apparatus for facilitating changes to print settings after a file is generated with an application.

In one embodiment, the invention includes a method of modifying print settings. The method comprises steps of receiving print settings; modifying an existing header file associated with a file having information to be printed to include the received print settings; and transmitting the header file with the associated file to a printing device.

In another embodiment, the invention comprises a system including a computing device, at least one printing device, an input device and an output device. The computing device executes an application and a printer driver generates a file to be printed. The computing device also executes a print settings software, wherein the print settings software is configured to receive print settings and modify the file to include the print settings.

The methods of the invention include steps that may be performed by computer-executable instructions executing on a computer-readable medium.

In comparison to known prior art, certain embodiments of the invention are capable of achieving certain aspects. For example, certain embodiments need less memory than conventional printing techniques to facilitate a print setting change. A user may change any print setting that can be controlled by the printer without the need to regenerate the file being transmitted to the printer. Also, certain embodiments reduce the need to have complicated control panels built into printers. Those skilled in the art will appreciate these and other aspects of various embodiments of the invention upon reading the following detailed description of a preferred embodiment with reference to the below-listed drawings.

### BRIEF DESCRIPTION OF THE DRAWINGS

The present invention is illustrated by way of example and not limitation in the accompanying figures in which like numeral references refer to like elements, and wherein:

FIG. 1 is a diagram of an exemplary system employing principles of the invention;

FIG. 2 illustrates the flow of data in the system shown in FIG. 1;

FIG. 3 is a flowchart of an exemplary method employing principles of the invention; and

FIG. 4 illustrates a conventional flow of data for printing information.

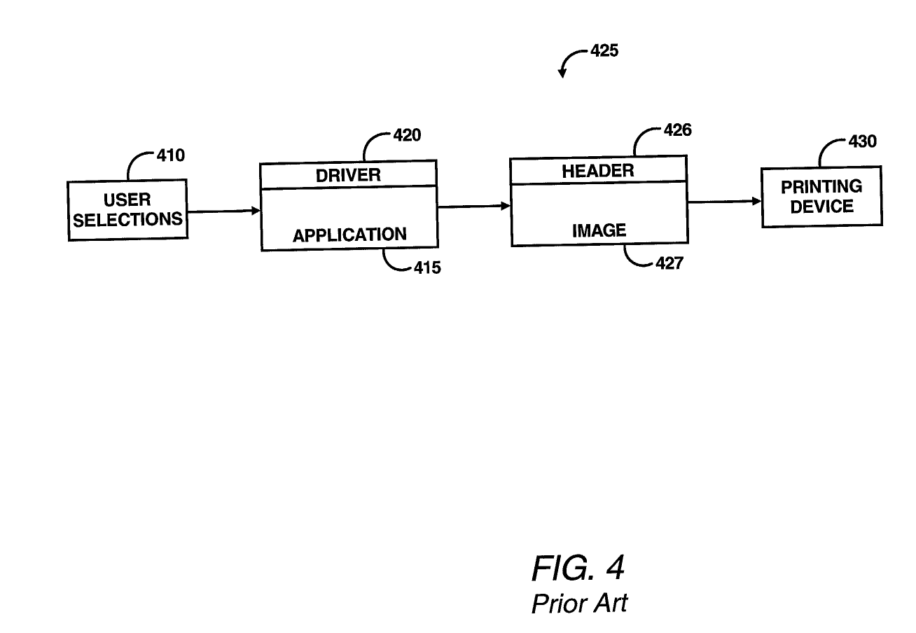

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

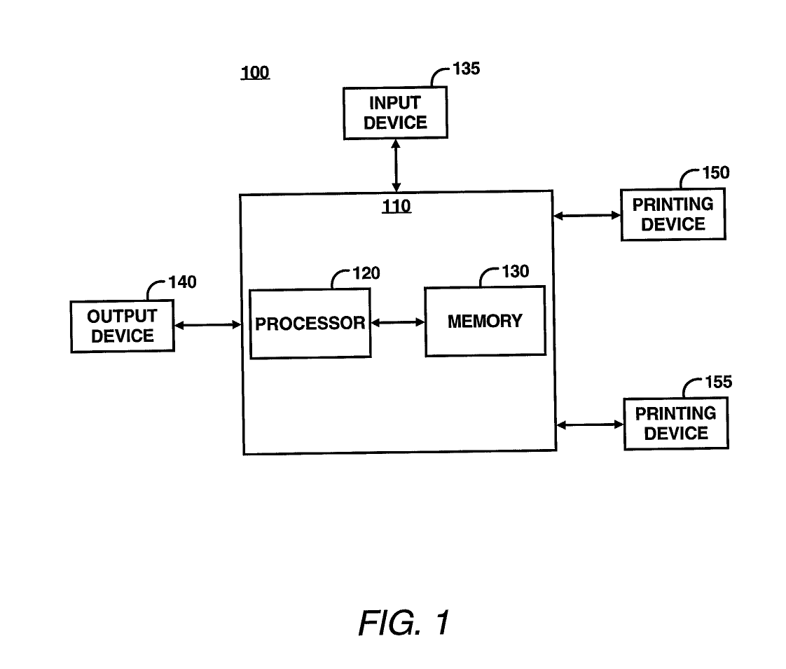

FIG. 1 is a diagram of an exemplary system 100 that may employ principles of the invention. This system 100 includes a computing device 110 connected to a printing device 150 and a printing device 155. The computing device 110 includes a processor 120 connected to a memory 130. The computing device 110 may also include a conventional input device 135 for receiving information input by a user and a conventional output device 140 for outputting information to the user.

The computing device 110 may include a traditional personal computer, or any other device (e.g., a web server, digital camera, personal digital assistant, etc.) that can interface with the printing devices 150 and 155 and has the capability of running applications which may print via the printing device 150 or 155. The connection from the computer 110 to the printing devices 150 and 155 may be a traditional cable, a remote network connection, a wireless network connection, an infrared connection, etc. The printing devices 150 and 155 may be any device that can print information (e.g., various printers, facsimiles, photocopiers, multifunction devices, and the like).

The computing device 110 may include other well known components and interfaces, not specifically disclosed. Also, it will be apparent to one of ordinary skill in the art that the computing device 110 may be integrated with a printing device. Furthermore, the computing device 110 may be connected to one printing device or three or more printing devices.

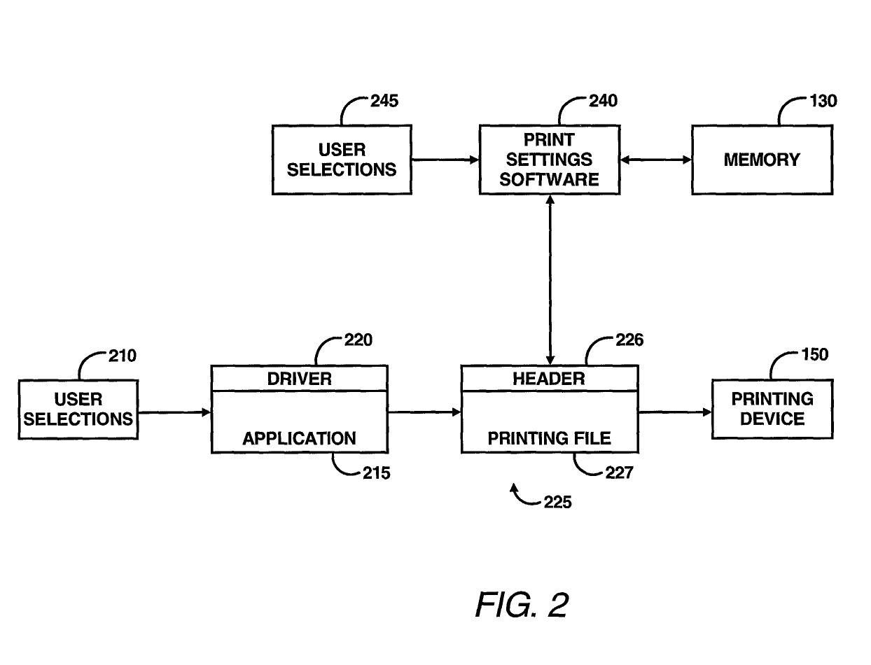

FIG. 2 illustrates a flow of data for generating and printing a file according to an embodiment of the invention. User print settings 210 are selected by a user, for example, with the input device 135 and received by an application 215. User print settings may include, among other things, selection of one of the printing devices 150 or 155, print settings that can be modified by the application 215 and print settings that may be modified by the selected printing device. The application 215 is also commonly referred to as a program. This application 215 refers to any computer program that is capable of issuing any type of request, either directly or indirectly, to print information. Examples of an application 215 include, but are not limited to, commonly used programs, such as word processors, spreadsheets, browsers, image programs, etc. Since the invention is not platform or even machine specific, other examples of applications 215 include any program written for any other device, including handheld or multimedia devices, that is capable of printing. The application 215 and other software (e.g., printer driver 220, print settings software 240, and the like, which are described in detail below) may be executed by the processor 120 on the computing device 110.

The application 215, in combination with a printer driver 220, generates a file 225 including the print settings selected by the user, default print settings and information to be printed. For example, the application 215 generates a printing file 227 including the information (e.g., image(s), text, graphics, and the like) to be printed. The application 215 also transmits the print settings to the printer driver 220 for the selected printing device (e.g., the printer driver associated with the printer selected for printing). The printer driver 220 generates a header file 226, including the print settings, that is packaged with the printing file 227 (i.e., the header file and the printing file are associated, such that the header file is transmitted to a printer just prior to the printing file so the printing device may adjust print settings to the settings in the header file).

The printer driver 220 includes software, which is typically separate from the application 215, interfacing with the application 215 and the printing device 250. The printer driver 220 includes print settings that may be modified by the printing device. The print settings in the printer driver 220 may be selected by a user, for example, through a GUI interface provided through the application 215. The printer driver 220 may include a conventional printer driver for configuring a file to be printed on an associated printer or other printing device. A printer driver may be loaded on the computing device 110 for each type of printing device that is connected to the computing device 110. Also, the printer driver 220 may include a generic printer driver that can facilitate printing on multiple printing devices. A generic printer driver may include minimal or no print settings.

A print settings software 240 facilitates modification of print settings after the file 225 is generated. The print settings software 240 may identify the printing device (e.g., the printing device selected by the user in the user selections 210) to be used for printing the file 225. The print settings software 240 can retrieve print settings information that can be modified by a printing device. For example, the memory 130 may store a database including print settings that can be modified at the printing device for multiple types of printers. These print settings, for example, include print settings that may be modified at the control panel for each type of printer. Some conventional printers may not have a control panel, but still are operable to adjust various print settings. These various print settings may also be stored in the memory 130. Print settings may include image orientation, predefined media sizes, color settings or options, quality levels, color emulations, and the like. These print settings may be modified by the printer (e.g., at the control panel or through other conventional means) prior to printing the file 225. The print settings software 240 may retrieve the settings that can be modified by the printer from the database, and display them to the user, for example, via the output device 140. The user may select and modify these print settings via the input device 135, as illustrated by the user selections 245 being input to the print settings software 240. The user selections 245 are received by the print settings software 240, and the print settings software 240 modifies the header file 226 with the user selections 245.

The file 225, comprising the modified header file 226 and the print file 227, is transmitted to the printing device 150 for printing. The printing device 150 parses the header file 226 and adjusts its print settings based on the user selections 245 incorporated in the modified header file 226.

In other embodiments, the memory 130 may store print settings only for printing devices that have associated printer drivers loaded on the computing device 110 or for each printing device 150 connected to the computing device 110 for minimizing the amount of memory consumed by the stored print settings information. Also, the print settings information may be stored in a database, table or other manner, such that the print settings information can be retrieved from the memory 130 by the print settings software 240. The print settings software 240 may include a distinct program or may be incorporated with a printer driver or other application.

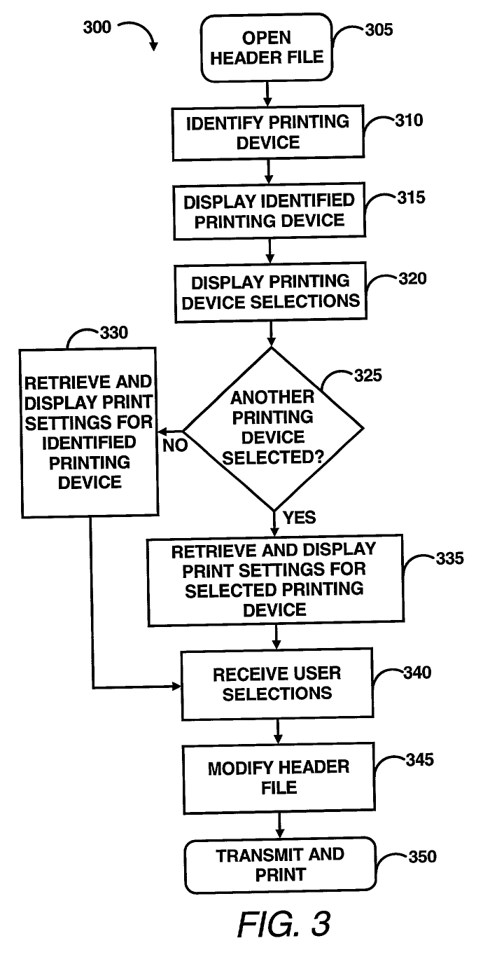

FIG. 3 illustrates an exemplary method 300 employing principles of the invention. In step 305 the print settings software 240 opens the header file 226. In step 310, the print settings software 240 identifies the printing device, which may have been previously selected in the user selections 210 or may have been a default print setting, from the header file 226. For example, the header file 226 includes information indicating that the print settings are for the printing device 150. The print settings software 240 parses the header file 226 to identify that the print settings in the header file 226 are for the printing device 150.

In step 315, the print settings software 240 displays the printing device (e.g., the printing device 150) identified in step 310 to the user via, for example, the output device 140. In one embodiment, the print settings software 240 may generate a display (e.g., a graphical user interface (GUI), and the like) including information, such as the selected printing device.

In step 320, the print settings software 240 displays information regarding other printing devices (e.g., a list of printing devices) that are connected to the computing device 110, such that a user may select a printing device (e.g., the printing device 155) other than the identified printing device. The information displayed in steps 315 may be incorporated into a single display page. In step 325, the print settings software 240 determines whether another printing device (e.g., the printing device 155) is selected by the user.

If another printing device is selected in step 325, the print settings software 240 displays the print settings for the newly selected printing device (e.g., the printing device 155) (step 335). For example, the print settings software 240 retrieves the print settings for the printing device 155 from the memory 130. The print settings may include the print settings that can be adjusted at the printing device 155, such as print settings adjusted using a control panel on the printing device 155 or adjusted by the printing device 155 using other conventional means. The print settings may be stored in a database, table, and the like that is in the memory 130. Additionally print settings for other types of printing devices may be downloaded from remote devices and stored locally in the memory 130. In one embodiment, the print settings software 240 may generate a GUI interface that simulates a control panel for a selected printing device.

If another printing device is not selected in step 325, the print settings software 240 displays the print settings for the printing device (e.g., the printing device 150) identified from the header file 226 in step 310 (step 330). For example, the print settings software 240 retrieves the print settings for the printing device 150 from the memory 130. The print settings may include the print settings that can be adjusted at the printing device 150, such as print settings adjusted using a control panel on the printing device 150. The print settings may be stored in a database, table, and the like that is in the memory 130. Additionally print settings for other types of printing devices may be downloaded from remote devices and stored locally in the memory 130. In one embodiment, the print settings software 240 may generate a GUI interface that simulates a control panel for a selected printing device.

In step 340, the user selects displayed print settings, and the user selections (e.g., the user selections 245) are received by the print settings software 240. In step 345, the header file 326 is modified by the print settings software 240 to include the user selections from step 340. For example, the print settings selected in step 340 may overwrite corresponding print settings already in the header file 226. Also, if a new printing device is selected (e.g., the printing device 155), then the print settings for the previously selected printing device (e.g., the printing device 150) that may not be modified by the current selected printing device (e.g., the printing device 155) may be deleted.

In step 350, the file 225 is transmitted to the selected printing device and printed with the modified print settings.

It will be apparent to one of ordinary skill in the art that some of the steps may be omitted from the method 300 and/or the steps may be performed in different orders without departing from the spirit and scope of the invention. For example, the step 310 or the step 325 may be omitted, and print settings may be selected for either the identified printing device or the selected printing device. Also, these steps may be performed in different orders. Furthermore, a header file (e.g., the header file 326) may be generated or modified, such that information to be printed (e.g., the file 225) that is associated with the header file may be printed by one or more printing devices.

The method 300 can be performed by a computer program. That is, the SNMP configuration generation tool 100 can be a computer program. The computer program can exist in a variety of forms both active and inactive. For example, the computer program and objects can exist as software comprised of program instructions or statements in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method of modifying print settings, the method comprising steps of:
receiving print settings;
modifying an existing header file associated with a file having information to be printed to include the received print settings; and
transmitting the header file with the associated file to a printing device.

2. The method of claim 1, further comprising a step of printing the information at the printing device with the received print settings.

3. The method of claim 1, further comprising steps of:
identifying a printing device for printing the information from the header file; and
displaying print settings for the identified printing device.

4. The method of claim 3, wherein the step of receiving print settings further comprises receiving print settings selected from the displayed print settings for the identified printing device.

5. The method of claim 1, further comprising a step of receiving a selection of a printing device.

6. The method of claim 5, wherein the step of receiving a selection of a printing device further comprises steps of:
displaying a list of printing devices that are operable to print the information; and
receiving a selection of a listed printing device from a user.

7. The method of claim 5, wherein the step of receiving print settings further comprises a step of receiving print settings for the selected printing device.

8. The method of claim 7, wherein the step of receiving print settings further comprises steps of:
displaying print settings for the selected printing device; and
receiving print settings selected by a user from the displayed print settings.

9. The method of claim 1, wherein the step of receiving print settings further comprises a step of receiving print settings that are modifiable by the printing device.

10. A system including a computing device, at least one printing device, an input device and an output device, the computing device executing an application and a printer driver generating a file to be printed and executing a print settings software, wherein the print settings software is configured to receive print settings and modify the file to include the print settings.

11. The system of claim 10, wherein the computing device transmits the modified file to the at least one printing device for printing.

12. The system of claim 10, wherein the print settings software is configured to identify the at least one printing device for printing the information from the file, and display print settings for the identified printing device on the output device.

13. The system of claim 12, wherein the input device receives print settings input by a user.

14. The system of claim 10, wherein the at least one printing device includes a plurality of printing devices, and the print settings software is configured to receive a selection of one of the plurality of printing devices.

15. The system of claim 14, wherein the print settings software is configured to display a list of the plurality of printing devices that a user selects from for printing the file.

16. The system of claim 10, wherein the received settings are print settings that are modifiable by the at least one printing device.

17. The system of claim 10, wherein the file includes a header file and a file including information to be printed, and the print settings software is configured to modify the header file with the received print settings.

18. A computer readable medium on which is embedded a program, the program performing a method for determining a network data collection configuration for an entity utilizing a computer network, the method comprising the steps of:
receiving print settings;
modifying an existing header file associated with a file having information to be printed to include the received print settings; and
transmitting the header file with the associated file to a printing device.

19. The computer readable medium of claim 18, wherein the method further comprises a step of printing the information at the printing device with the received print settings.

20. The computer readable medium of claim 18, wherein the method further comprises steps of:
identifying a printing device for printing the information from the header file; and
displaying print settings for the identified printing device.
